(19) United States
(12) Patent Application Publication
(10) Pub. No.: US 2015/0312884 A1
(43) Pub. Date: Oct. 29, 2015

(54) NOTIFICATION SYSTEM FOR ELECTRONIC DEVICES

(71) Applicant: Nolo Inc., Henderson, NV (US)

(72) Inventor: Denis Kharitonov, Kursk (RU)

(73) Assignee: NOLO INC., Henderson, NV (US)

(21) Appl. No.: 14/696,761

(22) Filed: Apr. 27, 2015

Related U.S. Application Data
(60) Provisional application No. 61/985,186, filed on Apr. 28, 2014.

(51) Int. Cl. H04W 68/00; H04W 4/14

(52) U.S. Cl. CPC H04W 68/00; H04W 4/14

(57) ABSTRACT

A case for electronic devices is provided. In some embodiments, the case may comprise an outer case configured to receive an electronic device and an electronic circuit board retained within the outer case. The electronic circuit board may include a microcontroller and a communication array configured to receive electronic notifications from the electronic device, with the communication array in electronic communication with the microcontroller. The case may also comprise a display element in electronic communication with the microcontroller and configured to provide a visual display signal in response to a notification transmitted from the electronic device to the case. In further embodiments, the case may comprise a first display element and a second display element and the first display element may be activated after receiving an incoming call notification and the second display element may be activated after receiving an SMS message notification.

### CROSS REFERENCE TO RELATED APPLICATIONS

This application claims priority to and the benefit of the filing date of U.S. Provisional Application No. 61/985,186, filed on Apr. 28, 2014, entitled “NOTIFICATION SYSTEM FOR ELECTRONIC DEVICES”, which is hereby incorporated by reference in its entirety.

### FIELD OF THE INVENTION

This patent specification relates to the field of notification systems for use with electronic devices. More specifically, this patent specification relates to a notification system configured to attach to an electronic device and display notifications using the ambient energy emitted from the electronic device.

### BACKGROUND

Electronic devices such as cell phones, tablet computers, laptops, and similar devices are used for many types of communications. The device may notify a user when communication is received by a plurality of actions such as turning on the screen, flashing a light, vibrating, or playing a sound. These notifications may be repeated for a specified period of time, or repeated until the user acknowledges receipt of the communication. These notifications are powered by the device's battery and ultimately increase the rate of battery discharge.

Unfortunately, a large number of electronic devices are only able to provide audible notifications. These audible notifications can be embarrassing or inappropriate depending on the social context or time of day. This is also true for vibration notifications which may mimic an audible notification by approximating a loud buzzing noise. For this reason, many users of electronic devices silence these audile and vibrational notifications and therefore may miss an important notification.

Some notification systems on electronic devices attempt to solve the problems associated with audible notification with visual notifications provided with a notification light. Unfortunately, the notification light is typically unable to distinguish different types of notifications from each other requiring the user to activate the display of the electronic device in order to find out what the notification is for. Additionally, a large number of electronic devices do not even possess a notification light therefore precluding the use of this type of notification by these devices.

Therefore, a need exists for novel notification systems for electronic devices. There is a further need for novel notification systems for electronic devices that are able to provide notifications when audible and vibrational notifications on the electronic device have been turned off or muted. Finally, there exists a need for novel notification systems for electronic devices that are able to distinguish different types of notifications received by the electronic device.

### BRIEF SUMMARY OF THE INVENTION

A case and system for electronic devices is provided. In some embodiments, the case may comprise an outer case configured to receive an electronic device and an electronic circuit board retained within the outer case. The electronic circuit board may include a microcontroller and a communication array configured to receive electronic notifications from the electronic device, with the communication array in electronic communication with the microcontroller. The case may also comprise a display element in electronic communication with the microcontroller and configured to provide a visual display signal in response to a notification transmitted from the electronic device to the case.

In further embodiments, the display element may be in electronic communication with the microcontroller and configured to provide a visual display signal in response to a notification such as an incoming call notification, an SMS message notification, a MMS message notification, a program or application notification, a voice mail notification, missed call notification, or a data network connectivity notification which may be transmitted from the electronic device to the case.

In further embodiments, the case may comprise a first display element and a second display element and the first display element may be activated after receiving an incoming call notification and the second display element may be activated after receiving a message such as an SMS message notification, a viber message notification, a whatsapp message notification, a skype message or incoming call notification, a Facebook message notification, etc. and the like.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a rear perspective exploded view of an example of a notification system for an electronic device according to various embodiments described herein.

FIG. 2 illustrates a rear perspective exploded view of an alternative example of a notification system for an electronic device according to various embodiments described herein.

FIG. 3 shows a plan view of the back of an example of a notification system for an electronic device according to various embodiments described herein.

FIG. 4 depicts a plan view of the back of an alternative example of a notification system for an electronic device according to various embodiments described herein.

FIG. 5 illustrates a plan view of the top of an example of a notification system for an electronic device according to various embodiments described herein.

FIG. 6 shows a plan view of the bottom of an example of a notification system for an electronic device according to various embodiments described herein.

FIG. 7 depicts a plan view of the top of an example of a notification system for an electronic device according to various embodiments described herein.

FIG. 8 illustrates an elevation view of the side of an example of a notification system for an electronic device according to various embodiments described herein.

FIG. 9 shows an elevation view of the other side of an example of a notification system for an electronic device according to various embodiments described herein.

FIG. 10 depicts a block diagram illustrating an example of a notification system for an electronic device according to various embodiments described herein.

FIG. 11 illustrates a block diagram illustrating an example of an electronic device or machine such as a smart phone which may be used with the system as described in various embodiments herein.

FIG. 12 shows a flow chart that illustrates an example of a method of establishing electronic communication between a case of a notification system and an electronic device according to various embodiments described herein.

FIG. 13 depicts a flow chart that illustrates an example of a notification method of a notification system for an electronic device according to various embodiments described herein.

FIG. 14 illustrates a flow chart that illustrates an example of a notification method of a notification system for an electronic device according to various embodiments described herein.

FIG. 15 shows a flow chart that illustrates an example of a notification method of a notification system for an electronic device according to various embodiments described herein.

FIG. 16 illustrates a block diagram depicting another alternative example of a notification system for electronic device according to various embodiments described herein.

FIG. 17 depicts a flow chart that illustrates an example of a method which may be carried out with another alternative example of a notification system for an electronic device according to various embodiments described herein.

### DETAILED DESCRIPTION OF THE INVENTION

Definitions

The term “electronic device” as used herein is preferably a type of electronic device comprising circuitry and configured to generally perform functions such as receiving and transmitting voice, text, and video communication, recording photos, and videos; displaying or reproducing audio, photos, and videos; storing, retrieving, or manipulation of electronic data; providing electrical communications and network connectivity; or any other similar function. Non-limiting examples of electronic devices include; cell phones including iOS phones made by Apple Inc., Android OS phones, Microsoft OS phones, Blackberry phones, digital music players, personal computers (PCs), workstations, laptops, tablet PCs including the iPad, or any electronic device capable of running computer software and displaying information to a user, memory cards, other memory storage devices, digital cameras with optical zoom and/or lens attachments, external battery packs, external charging devices, HDMI in/out adapters, projectors, and the like. Certain types of electronic devices which are portable and easily carried by a person from one location to another may sometimes be referred to as a “portable electronic device” or “portable device”. Some non-limiting examples of portable devices include; cell phones, smart phones, tablet computers, laptop computers, wearable computers such as watches, Google Glasses, etc. and the like.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

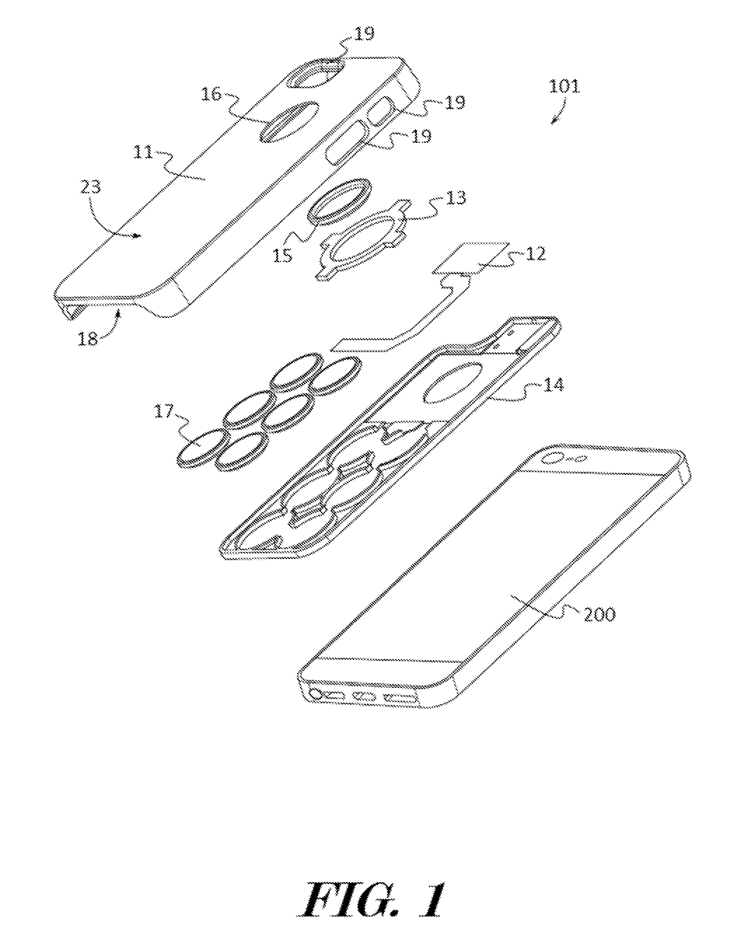

For purposes of description herein, the terms “upper”, “lower”, “left”, “rear”, “right”, “front”, “vertical”, “horizontal”, and derivatives thereof shall generally relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

New notification systems for use with electronic devices are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

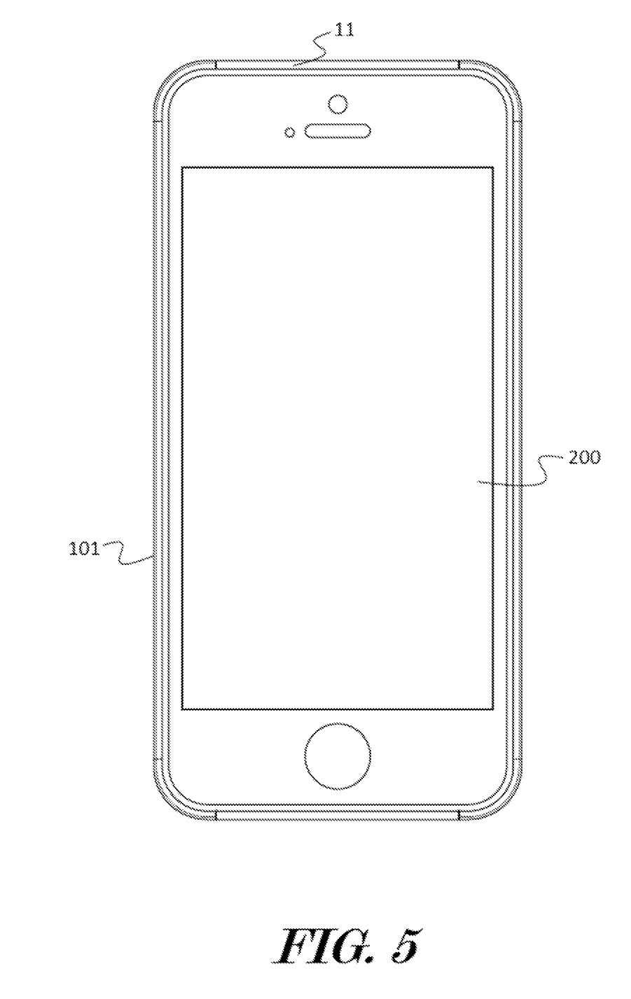

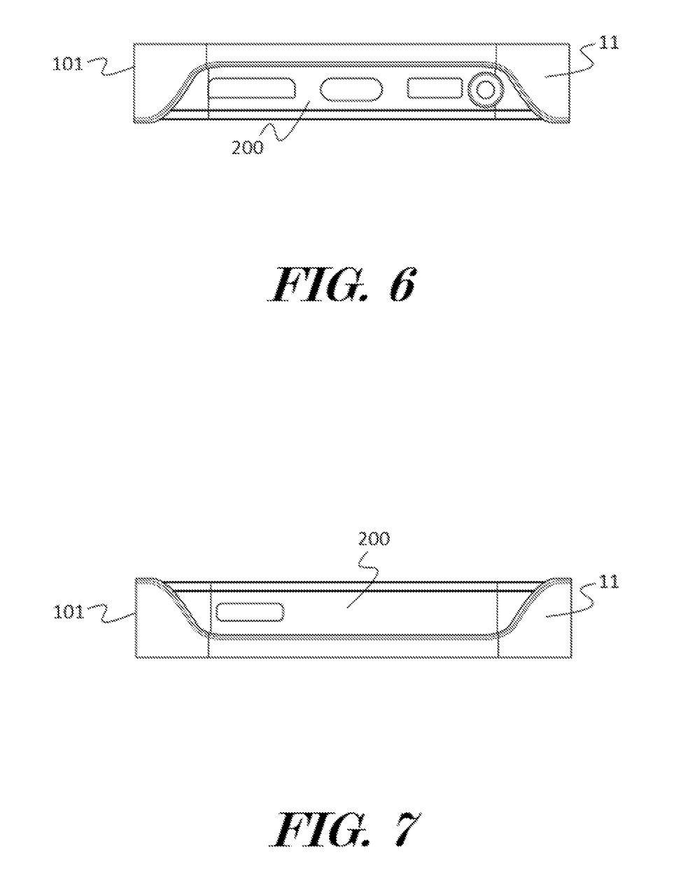

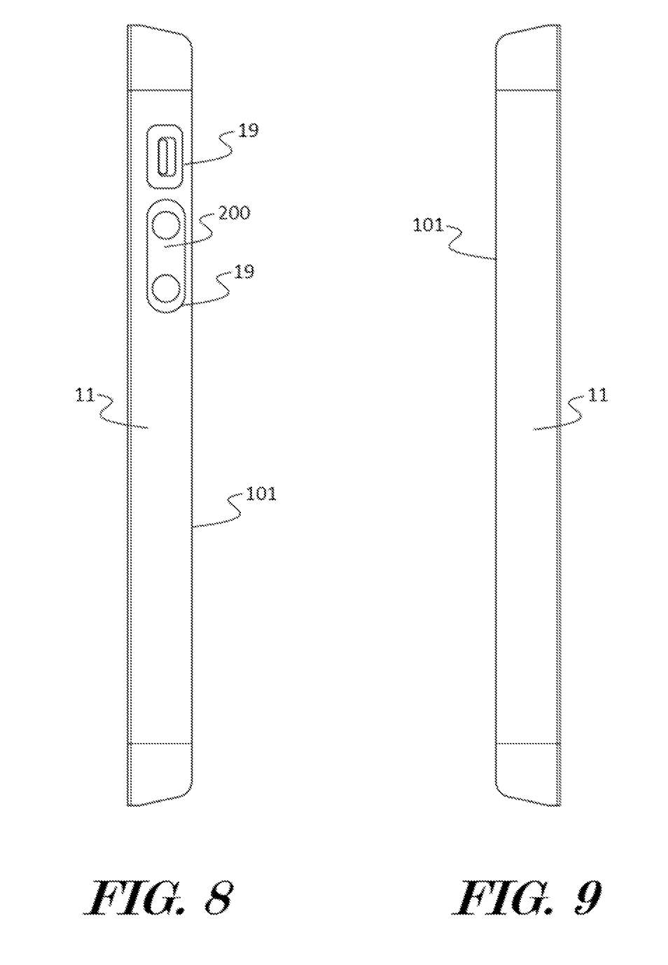

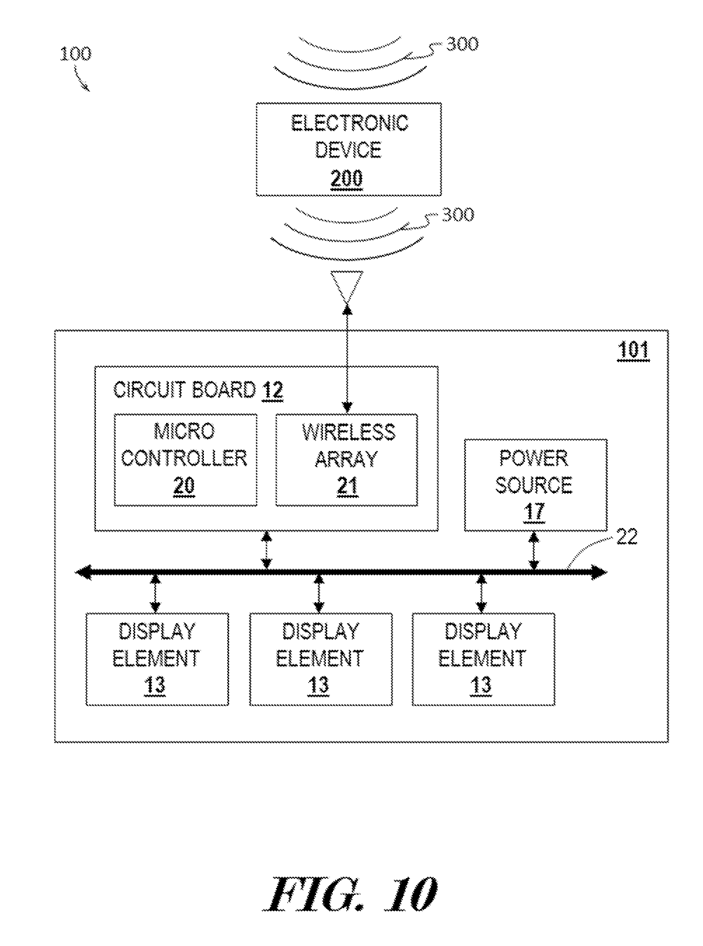

The present invention will now be described by referencing the appended figures representing preferred embodiments. FIG. 1 and illustrates a rear perspective exploded view of an example of an electronic device case (“the case”) 101 of a notification system for an electronic device (“the system”) 100 (FIGS. 1-15) for use with an electronic device 200 according to various embodiments described herein. In this example, the case 101 comprises an outer case 11 configured to receive an electronic device 200 and comprising an optional notification portal 16, a circuit board 12, and a display element 13. The case 101 may also comprise a case backing 14 having an optional bezel 15 which may be configured to align and position a display element 13 with a notification portal 16. The case 101 may further comprise one or more power sources 17, such as button cells, which may be received by the case backing 14.

A bezel 15 may be configured in a plurality of sizes and shapes, such as the annular example shown in FIG. 1, a rectangular shape, a triangular shape, or any other shape which may be suitable for aligning or positioning a display element 13 with a notification portal 16. In further embodiments, a bezel 15 may be configured in a shape which is complementary to a display element 13 allowing the bezel 15 to optionally, reflect, refract, conduct, or otherwise direct light emitted by a display element 13 to or through one or more notification portals 16. A bezel 15 may be made from rigid materials, such as metal and metal alloys, rigid plastics, ceramics, wood, and glass, from resilient materials, such as silicone, rubber, and flexible plastics, or any other suitable material which may be used to contact and couple a display element 13 to a notification portal 16.

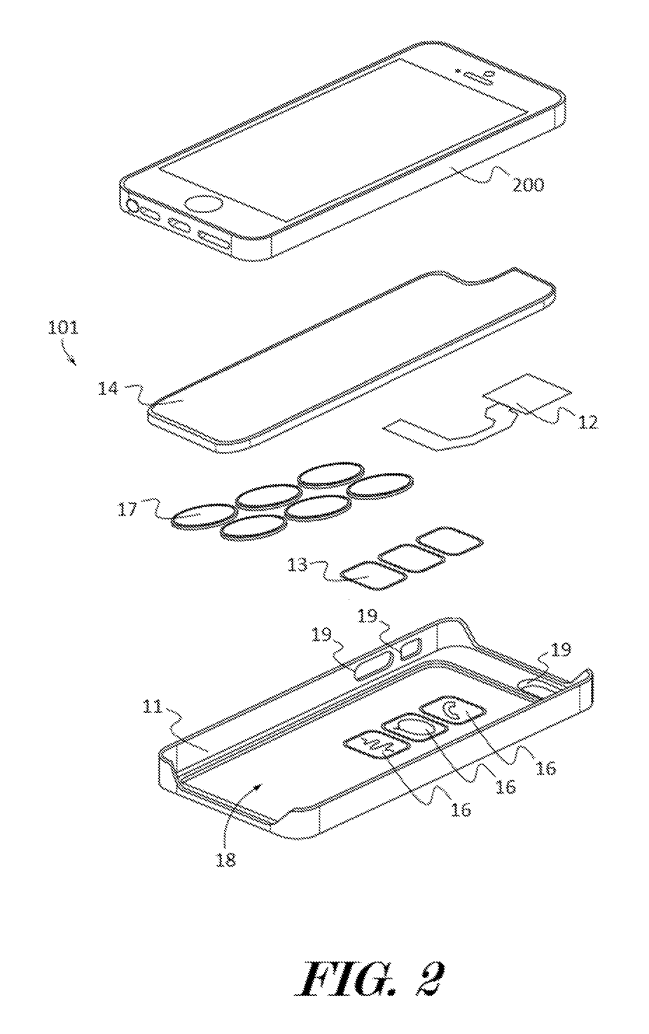

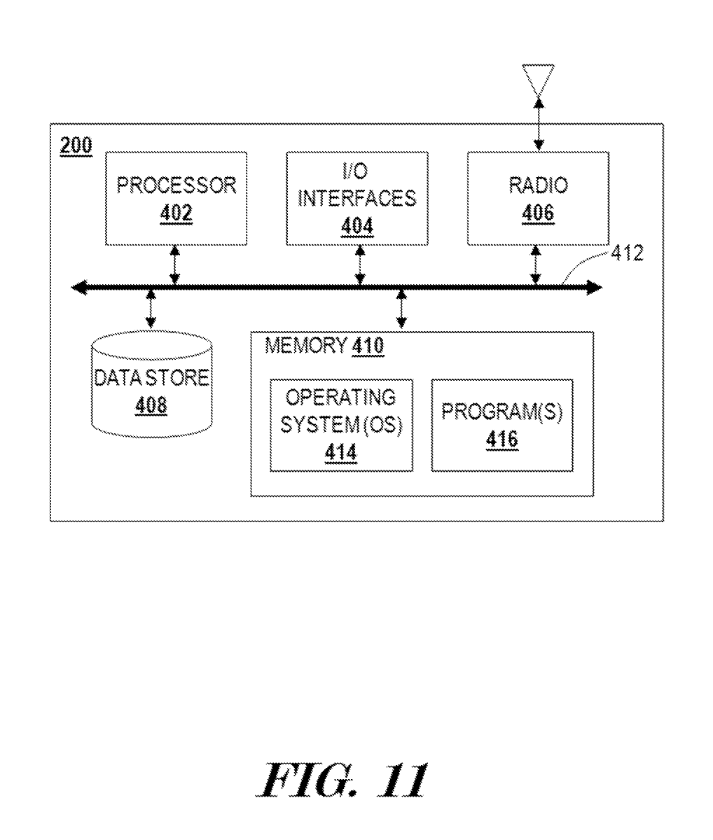

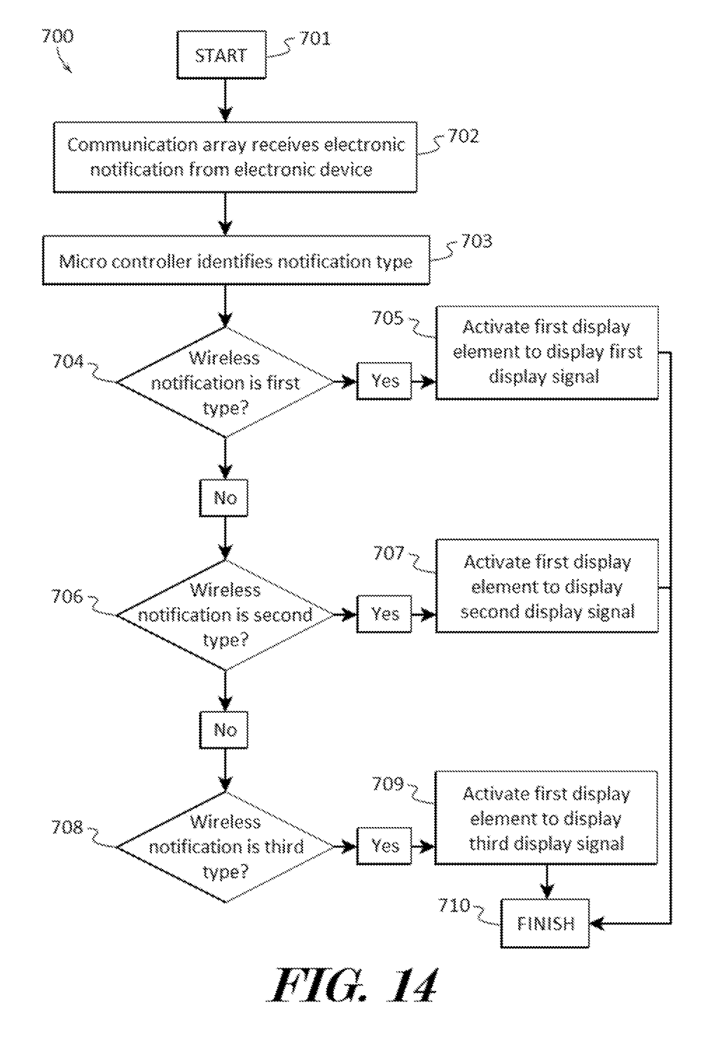

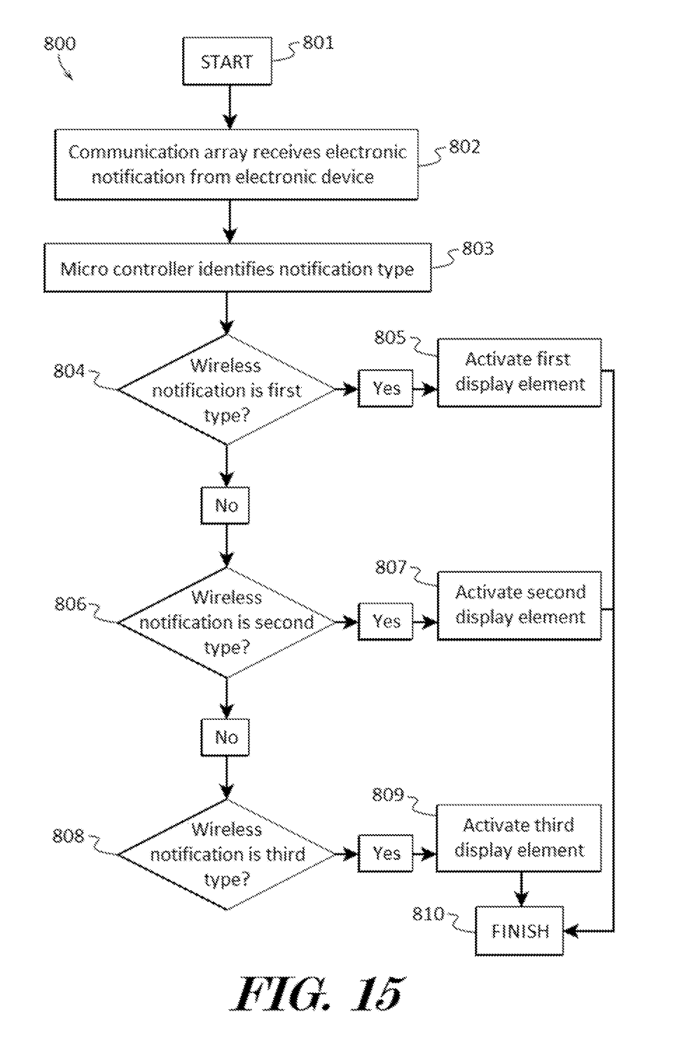

FIG. 2 illustrates a rear perspective exploded view of an alternative example of a case 101 of a notification system 100 (FIGS. 10 and 14) for an electronic device 200 according to various embodiments described herein. In this example, the case 101 comprises an outer case 11 configured to receive an electronic device 200 which includes three notification portals 16, a circuit board 12, and a display element 13. The case 101 may also comprise a case backing 14 and one or more power sources 17, such as button cells, which may be received by the case backing 14. In this and some embodiments, a display element 13 may be coupled to the case backing 14 and/or to the outer case 11 to align or position the display element 13 with a notification portal 16.

As shown in FIGS. 1 and 2, when assembled together, an outer case 11 and optionally a case backing 14 may define a case opening 18 in the front of the case 101 configured to allow the case 101 to receive an electronic device 200. The outer case 11 may comprise a rear exterior surface 23 which may be located opposite to the case opening 18. In other embodiments, the outer case 11 may define a case opening 18 in the front of the case 101 configured to receive an electronic device 200 through which the user can view and access the touch screen, home button, and other like components of the electronic device 200. As shown in these figures, a case opening 18 may have a generally rectangular prism shape which is open on the front side, with the shape of the back of the case opening 18 configured to be generally complementary in shape to an electronic device 200 also configured with a generally rectangular prism shape. In other embodiments, a case opening 18 may comprise any other shape, allowing the case opening 18 to receive any other shaped electronic device 200 so that the display screen and optionally one or more user inputs on the front of the electronic device 200 may be accessed.

In some embodiments, the shape of the case opening 18 may be configured to be slightly smaller than the shape of the electronic device 200 that is to be received into the case 101 with portions of the outer case 11 that surround or form the case opening 18 comprising a resilient material. The resilient material may be conformed around portions of a electronic device 200 received in the case opening 18 of the case 101 with the resilient nature of the material frictionally securing the electronic device 200 within the case opening 18.

In further embodiments, the shape of the case opening 18 may be configured to be generally the same size and shape of the electronic device 200 that is to be received into the case 101 with portions of the outer case 11 configured to temporarily conform around portions of the electronic device 200 received in the case opening 18 of the case 101. For example, the outer case 11 may comprise two or more temporarily coupled subunits which when uncoupled may be place around portions of an electronic device 200 and then coupled to secure the electronic device 200 within the case opening 18.

Referring now to FIGS. 1-9, the outer case 11 may be configured to retain and be coupled to the electronic circuit board 12 and may comprise one or more apertures 19 which are configured to provide access to one or more components of an electronic device 200 received in the outer case 11. Optionally, the case 101 may comprise a case backing 14 to facilitate manufacturing by allowing elements, such as a power source 17, circuit board 12, and the display elements 13, to be assembled and then coupled to the case 101 by being encased between the outer case 11 and the case backing 14. The optional case backing 14 may be configured to be coupled to the circuit board 12 and/or the outer case 11, thereby encasing elements, such as a power source 17, circuit board 12, and the display elements 13, between the outer case 11 and the case backing 14. In alternative embodiments, elements, such as a power source 17, circuit board 12, and the display elements 13, may be encased solely in the outer case 11 with the outer case 11 formed or coupled around the elements. In further alternative embodiments, a circuit board 12 may be encased solely in a case backing 14 with the case backing 14 formed or coupled around the elements, such as a power source 17, circuit board 12, and the display elements 13. In further alternative embodiments, elements, such as a power source 17, circuit board 12, and the display elements 13, may not be encased by the outer case 11 and/or a case backing 14 so that portions of the elements may be visible or accessible without removing portions of a the outer case 11 and/or a case backing 14.

In some embodiments, the outer case 11 and/or a case backing 14 may comprise or be constructed from a resilient material such as softer polymer, elastomer, rubber, silicone foams, rubber foams, plastic foams, neoprene foam, latex foam rubber, polyurethane foam rubber, or elastomer materials such as elastic plastics, elastic silicone, elastic rubbers, silicone rubbers, or any other suitable elastomer or resilient material to increase protection of the case 101 against drops and shocks. Optionally, the outer case 11 and/or a case backing 14 may be integrally formed as a single unit (e.g. through a molding manufacturing process).

In some embodiments, the outer case 11 and/or a case backing 14 may comprise a substantially rigid material such as nylon, polytetrafluoroethylene (PTFE), polyethylene terephthalate (PET), high-density polyethylene (HDPE), polyvinyl chloride (PVC), polypropylene (PP), low density polyethylene (LDPE), other substantially rigid plastics, hard rubbers, resins, ceramics, wood, carbon fiber, glass, metals and metal alloys, or any other suitable substantially rigid material including combinations of materials.

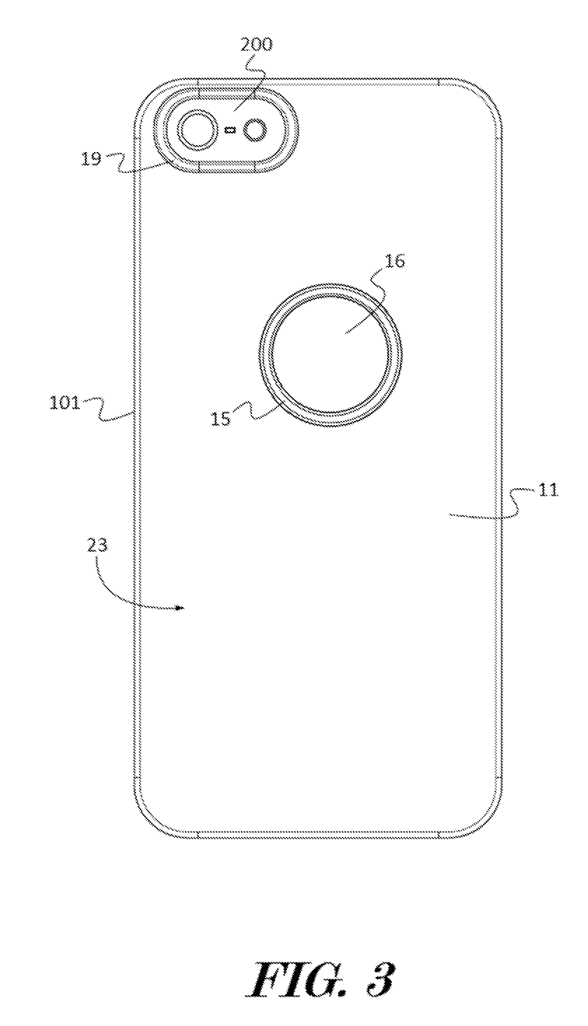

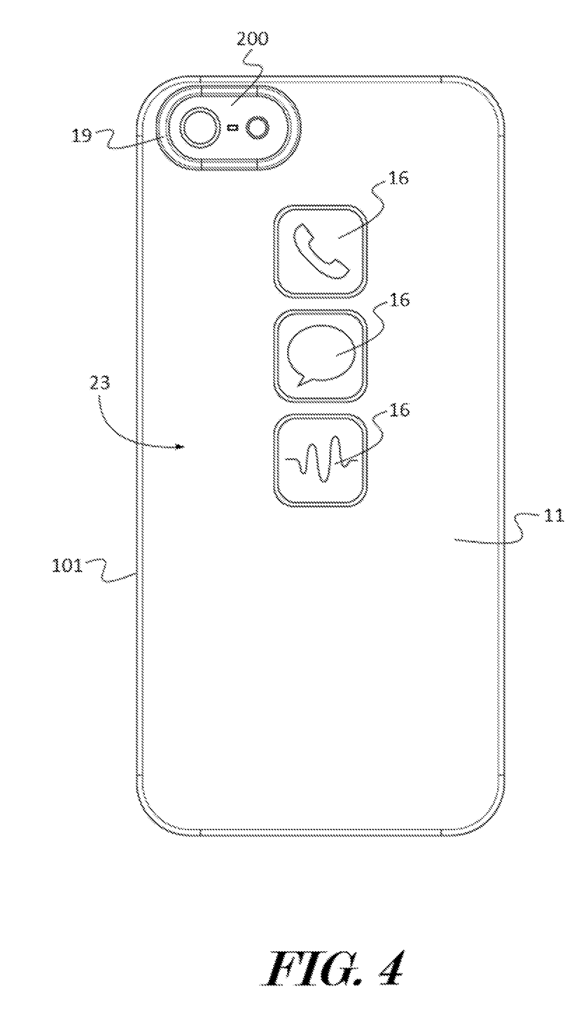

Turning to FIGS. 1 and 3 and to FIGS. 2 and 4, an example of a case 101 comprising a display element 13 and an alternative example of a case 101 comprising three display elements 13 according to various embodiments described herein are depicted, respectively. In some embodiments, a case 101 may comprise one, two, three, four, five, six, seven, eight, or more display elements 13. The display elements 13 may be configured to provide a visual notification such as a visual light display through one or more notification portals 16 positioned on the rear exterior surface 23 of the outer case 11. In further embodiments, a case 101 may comprise one, two, three, four, five, six, seven, eight, or more notification portals 16, with each display element 13 in communication with at least one notification portal 16. Generally, a notification portal 16 may be in optical or light communication with a display element 13 by allowing information lighted from a display element 13 to be visually communicated through the outer case 11 and observed by a user.

A notification portal 16 may be configured in a plurality of sizes and shapes, such as a circular example shown in FIGS. 1 and 3, a rectangular shape as shown in FIGS. 2 and 4, a triangular shape, or any other shape which may be suitable for visually communicating information from a display element 13 through a notification portal 16 to be observed by a user. In some embodiments, a notification portal 16 may be configured in a shape which is complementary to a display element 13 allowing the notification portal 16 to optionally, refract, conduct, or otherwise direct light emitted by a display element 13 to or through one or more notification portals 16. In further embodiments, a notification portal 16 may be made from rigid materials that are generally light transmissive, such as transparent or translucent rigid plastics, resins, glass, from transparent or translucent resilient materials, such as silicone, rubber, and flexible plastics, or any other suitable material which may be used to conduct light from a display element 13 through a notification portal 16 to be observed by a user. In still further embodiments, a notification portal 16 may comprise indicia, such as letters, words, numbers, symbols, graphics, logos, and the like which may allow transmited light from a display element 13 to be observed by a user. In still further embodiments, a notification portal 16 may comprise indicia such as one or more symbols which are commonly associated with notifications received by electronic devices 200 such as a phone handset symbol which is often associated with an incoming phone call notification, a text bubble symbol which is often associated with a text or SMS message notification, an electronic symbol which is often associated with a data network connectivity notification, or any other symbol which may or may not be associated with a type of notification which may be received by an electronic device 200. In alternative embodiments, a notification portal 16 may simply comprise an opening through the outer case 11 which may allow the notification portal 16 to conduct or otherwise direct light emitted by a display element 13 through the outer case 11 to be observed by a user.

FIG. 10 depicts a block diagram illustrating an example of a case 101 of a notification system 100 for an electronic device 200 according to various embodiments described herein. In this example, the case 101 comprises a microcontroller 20, a communication array 21, a power source 17, and three display elements 13. Electrical communication may be provided by a local interface 22 which can be, for example but not limited to, one or more buses or other wired or wireless connections, as is known in the art. In this and some embodiments, a microcontroller 20 and a Bluetooth module 21 may be provided electrical communication by a circuit board 12. In some embodiments, a circuit board 12 may comprise a printed circuit board (PCB) which mechanically supports and electrically connects electronic components using conductive tracks, pads and other features etched from copper sheets laminated onto a non-conductive substrate. PCBs can be single sided (one copper layer), double sided (two copper layers) or multi-layer. Conductors on different layers may be connected with plated-through holes called vias. In some embodiments, a circuit board 12 may only comprise copper connections and no embedded components and may be called a printed wiring board (PWB) or etched wiring board. In other embodiments, a circuit board 12 may comprise a printed circuit assembly (PCA), printed circuit board assembly or PCB assembly (PCBA), a circuit card assembly (CCA), or a backplane assembly, or any other suitable electrical connection and communication method including standard wiring and the like.

In preferred embodiments, a communication array 21 may comprise a Bluetooth receiver and transmitter which enables wireless communication to a network or an external electronic device 200 such as cell phones, smart phones, tablet computers, laptop computers, wearable computers such as watches, Google Glasses, etc. and the like. In other embodiments, a communication array 21 may comprise a wired connection which may provide the exchange or input of data from an electronic device 200 to a case 101. A communication array 21 may be configured to receive wireless electrical communication or wired electrical communication comprising notifications 300 from the electronic device 200 and/or to receive electromagnetic radiation comprising notifications 300 sent to the electronic device 200. In other embodiments, a communication array 21 may comprise a receiver and transmitter which enables any number of suitable wireless data communication protocols, techniques, or methodologies including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); iBeacon; wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

A microcontroller 20 may comprise a small computer on a single integrated circuit typically used for embedded applications and preferably comprising a processor core, memory, and programmable input/output peripherals. A microcontroller 20 may be positioned within the electronic device case 101 and may be programmed to; receive a notification signal from the communication array 21; determine the type of notification received; and activate a display element 13 in response to the type of notification received. Program memory in the form of NOR flash or OTP ROM may also be included on chip, as well as a typically small amount of RAM. The microcontroller 20 may be configured to be in electronic communication and control one or more display elements 13 in response to information electrically communicated from the communication array 21 to the microcontroller 20.

A display element 13 may be configured to visually display a display signal by electronic communication from a microcontroller 20. Each display element 13 may be in electronic communication with the microcontroller 20 and configured to provide a visual display signal in response to a notification transmitted from the electronic device 200 to the case 101. A notification may be selected from one of an incoming call notification, an SMS message notification, a MMS message notification, a program or application notification, a voice mail notification, missed call notification, a data network connectivity notification, or any other notification which may be transmitted to or from an electronic device. In some embodiments, a display element 13 may comprise a light emitting element such as a light emitting diode (LED) which may be configured to provide light of various wavelengths and intensities. In other embodiments, a display element 13 may comprise an organic light-emitting diode (OLED), incandescent light bulb, halogen light bulb, laser light emitter, electroluminescent light source, neon light source, or any other type of suitable light emitting element. In still other embodiments, a display element 13 may comprise a Cathode ray tube display (CRT), Light-emitting diode display (LED), Electroluminescent display (ELD), Electronic paper display, E Ink display, Plasma display panel (PDP), Liquid crystal display (LCD), High-Performance Addressing display (HPA), Thin-film transistor display (TFT), Organic light-emitting diode display (OLED), Surface-conduction electron-emitter display (SED), Laser TV, Carbon nanotubes, Quantum dot display, and/or Interferometric modulator display (IMOD), or any other type of display which is able to emit, reflect, or otherwise influence light to provide visual information to a user based on data or electronic signals received from the electronic device 200.

A display signal may comprise a type of visual signal which may be displayed by a display element 13 and which may be observed by a user. Each display element 13 may be configured to produce or display one or more display signals. For example, a display element 13 may comprise a light emitting element such as an LED. The display element 13 may then be configured to display one or more display signals such as a blinking pattern of one or more colors and/or intensities of light or a continuous display of one or more colors and/or intensities of light. In another example, a display element 13 may comprise a display element such as a electrophoretic ink display, an LED display, or a LCD display. The display element 13 may then be configured to display one or more display signals such as one or more graphics, words, symbols, or other indicia.

In some embodiments, the case 101 may comprise a power source 17, such as a battery, which may provide electrical power to an element that may require electrical power and to any other electronic device or electronics that may optionally be in electrical communication with a local interface 22. In further embodiments, a power source 17 may comprise a lithium ion battery, nickel cadmium battery, alkaline battery, or any other suitable type of battery. In still further embodiments, a power source 17 may comprise a rechargeable or non-rechargeable battery which may or may not be removable from the case 101. In further embodiments, a power source 17 may comprise a rechargeable battery that may be charged by a battery charging element such as a kinetic or motion charging, or by inductive charging or other wireless power supply including near field magnetic resonance (NFMR) power transmission.

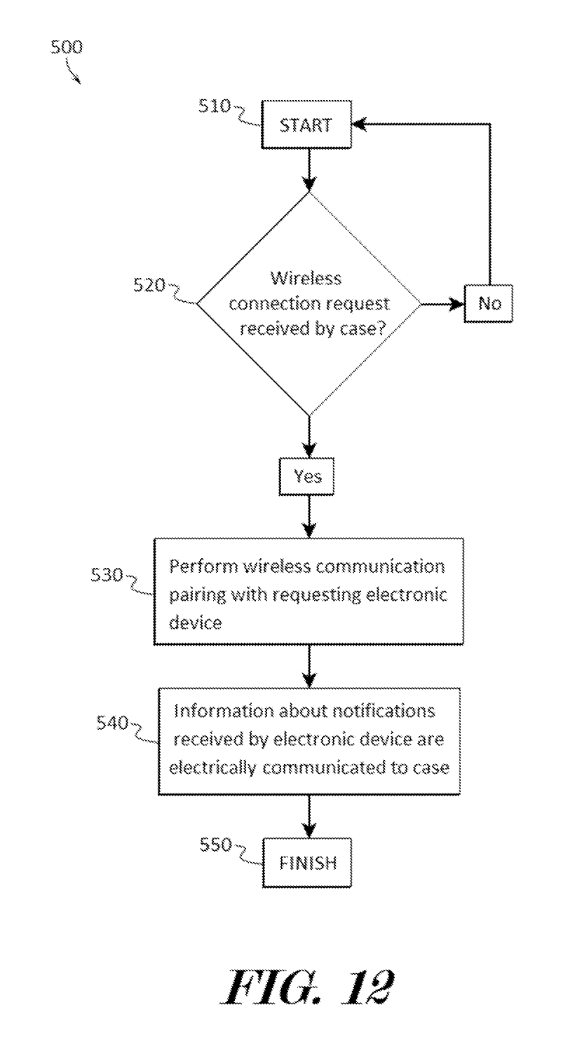

Referring to FIG. 11, in an exemplary embodiment, a block diagram illustrates an electronic device 200, which may be used with the system 100 (FIGS. 10 and 14) or the like. The electronic device 200 can be a digital device that, in terms of hardware architecture, generally includes a processor 402, input/output (I/O) interfaces 404, a radio 406, a data store 408, and memory 410. It should be appreciated by those of ordinary skill in the art that FIG. 11 depicts the electronic device 200 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the electronic device 200, a semiconductor-based microprocessor (in the form of a microchip or chip set), or generally any device for executing software instructions. When the electronic device 200 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications. The I/O interfaces 404 can be used to receive images through a camera and user input from and/or for providing system output. User input can be provided via, for example, a keypad, a touch screen, a scroll ball, a scroll bar, buttons, bar code scanner, voice recognition, eye gesture, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the electronic device 200. Additionally, the I/O interfaces 404 may further include an imaging device, i.e. camera, video camera, etc.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); VHF spectrum, AM spectrum, wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 11, the software in the memory system 410 includes a suitable operating system (O/S) 414 and programs 416. The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 416 may include various applications, add-ons, etc. configured to provide end user functionality with the electronic device 200. For example, exemplary programs 416 may include, but not limited to, a web browser, social networking applications, streaming media applications, games, mapping and location applications, electronic mail applications, financial applications, and the like. In a typical example, the end user typically uses one or more of the programs 416 along with a network to control function of the electronic device 200.

FIG. 12 shows a flow chart that illustrates an example of a method of establishing electronic communication (“the method”) 500 which may be implemented by a notification system 100 (FIGS. 10 and 14) comprising a case 101 (FIGS. 1-10) and an electronic device 200 (FIGS. 1, 2, 10, and 11) such as iOS phones made by Apple Inc., Android phones, and the like according to various embodiments described herein. In this embodiment, the method 600 may start 510 and the communication array 21 (FIG. 10) may determine if a wireless connection request has been received by the case 101 is step 520. In some embodiments, a wireless connection request may comprise a Bluetooth wireless communication such as a Bluetooth low-energy or Bluetooth 4.0 LE protocol to access notifications using Apple Notification Center Services (ANCS), however, a wireless connection request may comprise any type of wireless communication protocol. If a wireless connection request is not received, the method 600 may not progress. Once a wireless connection request has been received by the communication array 21, the communication array 21 of the case 101 may perform pairing with the requesting electronic device 200 in step 530. Once the case 101 has been paired, information about notifications received by the paired electronic device 200 may be wirelessly communicated to the case 101 in step 540 and the method 500 may end 550.

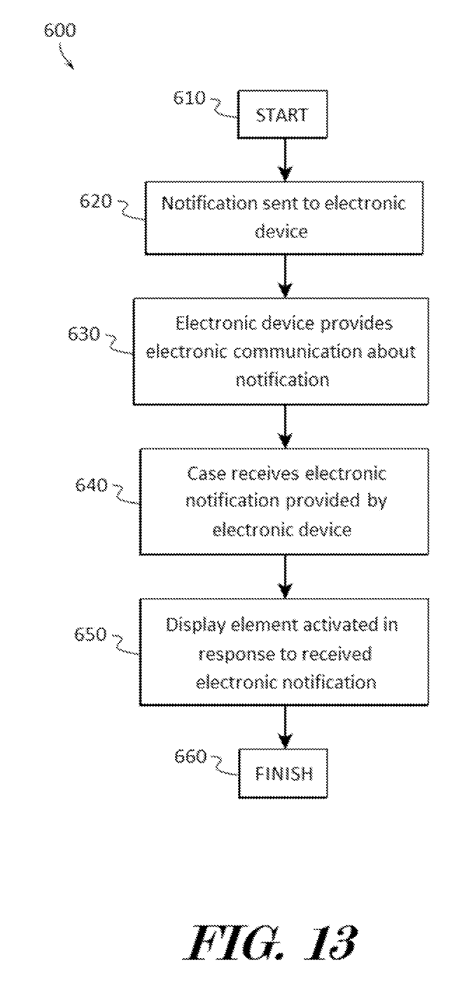

FIG. 13 depicts a flow chart that illustrates an example of a notification method (“the method”) 600 which may be implemented by a notification system 100 (FIGS. 10 and 14) comprising a case 101 (FIGS. 1-10, 16) and an electronic device 200 (FIGS. 1, 2, 10, and 11). In this embodiment, the method 600 may start 610 when a notification such as a wireless communication is sent to an electronic device 200 (FIGS. 1, 2, 10, and 11) which is in electronic communication with the case 101 in step 620. The electronic communication may comprise an incoming call notification, a text or SMS message notification, a data network connectivity notification, or any other type of notification which may be received by an electronic device 200. The electronic device 200 may then transmit a wireless notification by using its radio 406 (FIG. 11) or provide a wired electronic communication about the received notification to the case 101 in step 630. The electronic notification may comprise information on the type of wireless communication received, such as text message, voice message, MMS message, missed call, incoming call, and the like, and/or other information in the wireless communication, such as the text of a text message, graphics of a MMS message, the sender of a text or SMS message, and the like. In some embodiments, wireless notification about the received wireless communication may comprise a Bluetooth wireless communication such as a Bluetooth low-energy or Bluetooth 4.0 LE protocol to access notifications using Apple Notification Center Services (ANCS) and the like. In step 640, the communication array 21 (FIG. 10) of the case 101 may receive the wireless notification transmitted by the electronic device 200. Next, a display element 13 may be activated by the microcontroller 20 (FIG. 10) in response to the wireless notification received by the communication array 21 in step 650.

FIG. 14 depicts a flow chart that illustrates an example of a notification method (“the method”) 700 which may be implemented by a notification system 100 (FIGS. 10 and 14) comprising a case 101 (FIGS. 1 and 4) with one display element 13 (FIGS. 1, 2, and 10) and an electronic device 200 (FIGS. 1, 2, 10, and 11). In this embodiment, the method 700 may start 701 when the communication array 21 (FIG. 10) of the case 101 receives a wireless notification from the electronic device 200 in step 702. In other embodiments, the communication array 21 of the case 101 may receive a wired notification from the electronic device 200 in step 702. Information from or about the wired or wireless notification may be electrically communicated to the micro controller 20 (FIG. 10). The micro controller 20 may then identify the notification type, such as text message, voice message, MMS message, missed call, incoming call, and the like in step 703. In some embodiments, a case 101 may comprise one display element 13 as shown in FIGS. 1 and 3 which may activate in response to the type of notification received by the electronic device 200. The microcontroller 20 may run a rules engine or similar program to process and identify the type of the notification (for example by being programmed to work with ANCS). In step 704, if the microcontroller 20 determines that the wireless notification is a first notification type, such as an incoming call notification, the microcontroller 20 may then activate the display element 13 to display a first display signal in step 705. For example, a light emitting diode (LED) type display element 13 may display a first display signal of a series of slow flashes of light and/or a blue color of light generated by the light emitting diode. In step 706, if the microcontroller 20 determines that the wireless notification is a second notification type, such as an SMS, MMS, or text message notification, the microcontroller 20 may then activate the display element 13 to display a second display signal in step 707. For example, a light emitting diode (LED) type display element 13 may display a second display signal of a series of fast flashes of light and/or a red color of light generated by the light emitting diode. In step 708, if the microcontroller 20 determines that the wireless notification is a third notification type, such as a voice message, the microcontroller 20 may then activate the display element 13 to display a third display signal in step 709. For example, a LED type display element 13 may display a third display signal of a solid display of light and/or a green color of light. The example method 700 of FIG. 14 depicts three different types of display signals, but one of average skill in the art will immediately recognize that a case 101 may comprise a display element 13 capable of producing many different display signals which may be used to visual indicate many different types of information about or in a wireless and/or wired notification which may be electrically communicated by the electronic device 200. Once a display signal has been produced by the display element 13, the method 700 may finish 710.

In another example, when a text message notification is received by the electronic device 200, a electronic notification may be communicated to the communication array 21, for example, by the radio 406 (FIG. 11) of the electronic device 200 (for example using ANCS) which may identify the notification as a text message type notification and then electrically communicate this information to the microcontroller 20 (FIG. 10) which may run a rules engine or similar program to process and identify the type of the notification (for example by being programmed to work with ANCS). The microcontroller 20 may then activate the display element 13 to illuminate in a first on and off pattern. In another example, when an incoming call notification is received by the electronic device 200, a wireless communication may be transmitted to the communication array 21 by the radio 406 (FIG. 11) of the electronic device 200 which may identify the received notification as an incoming call type notification and then electrically communicate this information to the microcontroller 20 (FIG. 10). The microcontroller 20 may then activate the display element 13 to illuminate in a second on and off pattern which may comprise a different color, intensity, and/or pattern than the first pattern corresponding to the text message notification. In further embodiments, display element 13 may be configured to generate a different pattern for each type of notification received by the electronic device 200. In still further embodiments, display element 13 may comprise an E ink display or any other type of display and be configured to display different indicia for each type of notification received by the electronic device 200.

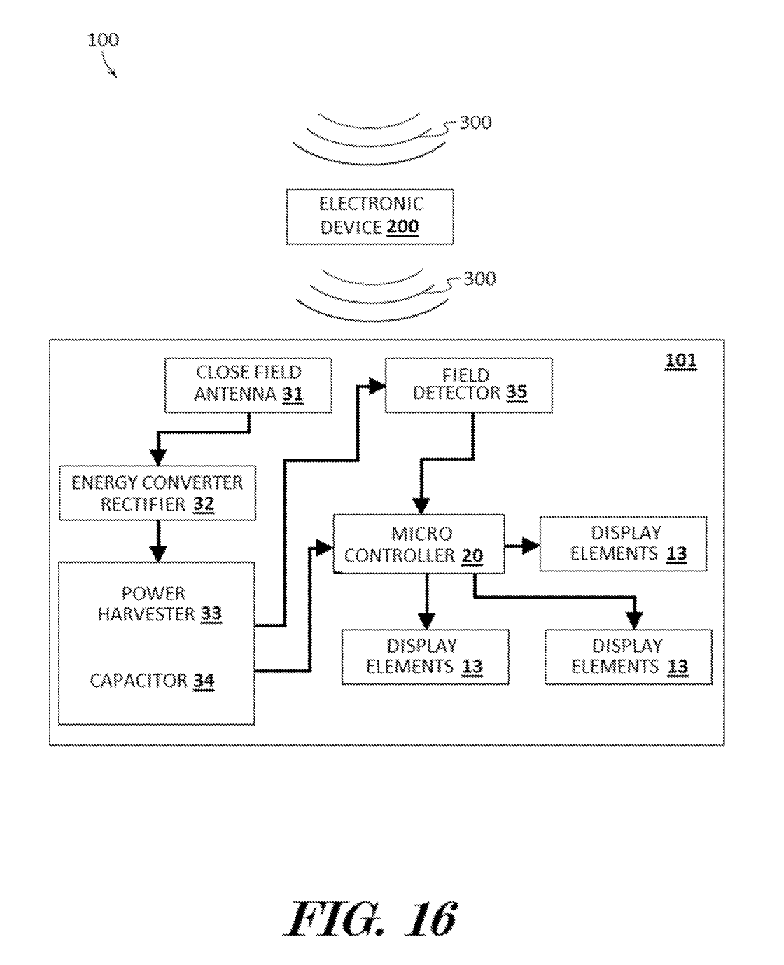

FIG. 15 depicts a flow chart that illustrates an example of a notification method (“the method”) 700 which may be implemented by a notification system 100 (FIGS. 10 and 14) comprising a case 101 (FIGS. 2, 4, 10) with more than one display element 13 (FIGS. 1, 2, and 10) and an electronic device 200 (FIGS. 1, 2, 10, and 11). In this embodiment, the method 800 may start 801 when the communication array 21 (FIG. 10) of the case 101 receives a wireless notification from the electronic device 200 in step 802. In other embodiments, the communication array 21 of the case 101 may receive a wired notification from the electronic device 200 in step 802. Information from or about the wired or wireless notification may be electrically communicated to the micro controller 20 (FIG. 10). The micro controller 20 may then identify the notification type, such as text message, voice message, MMS message, missed call, incoming call, and the like in step 803. In some embodiments, a case 101 may comprise two or more display elements 13, such as three display elements 13 as shown in FIGS. 2, 4, and 10, which may activate in response to the type of notification received by the electronic device 200. The microcontroller 20 may run a rules engine or similar program to process and identify the type of the notification (for example by being programmed to work with ANCS). In step 804, if the microcontroller 20 determines that the notification is a first type, such as an incoming call notification, the microcontroller 20 may then activate a first display element 13 in step 805 to display a display signal. For example, a LED type first display element 13 may display a display signal of a series of slow flashes of light and/or a blue color of light. In step 806, if the microcontroller 20 determines that the notification is a second type, such as an SMS, MMS, or text message, the microcontroller 20 may then activate the second display element 13 to display a display signal in step 807. For example, a LED type second display element 13 may display a display signal of a series of slow flashes of light and/or a blue color of light. In step 808, if the microcontroller 20 determines that the notification is a third type, such as a voice message, the microcontroller 20 may then activate the third display element 13 to display a display signal in step 809. For example, a LED type third display element 13 may also display a display signal of a series of slow flashes of light and/or a blue color of light. The example method 800 of FIG. 15 depicts a case 101 comprising three display elements 13 each configured to produce or display a similar type of display signal, but one of average skill in the art will immediately recognize that a case 101 may comprise any number of display elements 13 each capable of producing similar or many different display signals which may be used to visual indicate many different types of information about or in a wireless and/or wired notification which may be electrically communicated by the electronic device 200. Once a display signal has been produced by a display element 13, the method 800 may finish 810.

FIG. 16 illustrates a block diagram depicting another alternative example of a case 101 of a notification system 100 for an electronic device 200 according to various embodiments described herein. In this embodiment, case 101 may comprise a near field antenna 31 configured to receive electromagnetic radiation comprising notifications 300 from the electronic device 200 or to receive electromagnetic radiation comprising notifications 300 sent to the electronic device 200 and the power source 17 (FIGS. 1, 2, and 10) may comprise a power harvester 33. The near field antenna 31 may convert the electromagnetic radiation comprising notifications 300 to AC electricity which may be sent or communicated to a rectifier energy converter 32 which may convert the AC electricity into DC electricity. The DC electricity from the rectifier energy converter 32 may be communicated to a power harvester 33 which may be configured to optimize the rectifier energy converter 32 functioning to optimize the electricity supplied by the rectifier energy converter 32 to the capacitor 34 and to optimize electricity exiting the capacitor 18. Electricity stored in the capacitor 34 may be used to power an electromagnetic field detector 35 which may detect electromagnetic radiation comprising notifications 300 generated by the electronic device 200 and identify type and content of the notifications in addition to the mode of the electronic device 200 or telephone mode, such a silent mode, and communicate the mode and notifications received to the electronic device 200 to a microcontroller 20. Electricity stored in the capacitor 34 may also be used to power a microcontroller 20 which may be configured to activate one or more display element 13, such as light elements, electronic ink displays, liquid crystal displays (LCD), and the like once a notification is identified by the field detector 20. In preferred embodiments, the display elements 13 may display different notifications with information comprising the type and content of the notifications to the electronic device 200.

In some alternative embodiments, the case 101 comprises a near field antenna which may be positioned in a communication array 21 configured to receive ambient radiation from the electronic device 200. The communication array 21 may comprise one or more antennas such as a near field antennas or electromagnetic field detectors. The near field or near field are regions of the electromagnetic field around an object, such as the transmitting and receiving antenna of an electronic device 200, or produced as a result of radiation scattering off an object. Near field radiation intensity decays rapidly with distance away from an object with an inverse square law. The near field is governed by multipole type fields, which can be considered as collections of dipoles with a fixed phase relationship. The boundary of the near field region around an electronic device is only vaguely defined, and it depends on the dominant wavelength (λ) emitted by the device. A near field antenna may be configured to collect electromagnetic radiation from the environment including electromagnetic radiation common to communications devices such as Global System for Mobile Communications (GSM), General Packet Radio Service (GPRS), cdmaOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN), Wifi, Bluetooth, near field communications (NFC) and the like, and to convert it into alternating current (AC).

In some alternative embodiments, the communication array 21 may also comprise a rectifier such as a rectifier energy converter 32. Ambient radiation from the environment and the electronic device 200 may be collected by a near field antenna and the resulting AC electricity may be sent to a rectifier energy converter 32 to be converted to an acceptable form of energy for powering the case 101 of the notification system. In alternative embodiments, a rectifier energy converter 32 may be positioned in the bezel 12 or in the case 11. Preferably, the acceptable form of electricity may comprise direct current (DC). In preferred embodiments, an ultra-low-voltage active rectifier for energy harvesting applications with input voltages frequencies in the range of MHz to low kHz can be rectified into an acceptable form of electricity. In some embodiments, controls for optimization of the rectifier energy converter 32 may be positioned on the case 101, comprised of in a power harvester, or programmed into a microcontroller 20. In other embodiments, the acceptable form of electricity may comprise alternating current.

In some alternative embodiments, the communication array 21 may also comprise a capacitor 34, such as a super capacitor, and a power harvester 33. In preferred embodiments, the capacitor 34 may be in the same environment or housed within a power harvester 33. The power harvester 33 may be configured to optimize the rectifier energy converter 32 functioning to optimize the electricity supplied by the rectifier energy converter 32 to the capacitor 34 and to optimize electricity exiting the capacitor 34. In some embodiments, the power harvester may supply electricity from the capacitor 34 to a booster which may be used to power one or more display elements 13 such as light elements, LCD displays, or electronic ink displays in the case 101. The electricity may be stored in a capacitor 34 for use by the case 101. The power harvester 33 makes the charge of the capacitor 34 optimal. Further, this current is supplied to the PWM LED controller which feeds the display, which in alternative embodiments, may be positioned in the outer case 11 or in the bezel 12 and in direct communication with the rectifier energy converter 32. In other embodiments, the electricity may be stored in a power source such as a battery or other suitable electricity storage device. The capacitor 34 may be used to power the case 101 which may comprise one or more near field antennas, rectifier energy converters, power harvesters, field detectors, LED drivers, microcontrollers 20, and display elements 13 such as light elements, electronic ink displays, or liquid crystal displays.

In addition to optimizing the electricity exiting and entering the capacitor 34, in some embodiments, the power harvester 33 may be configured to supply power from the capacitor 34 to a microcontroller 20, such as a LED driver, and a field detector 35.

In some alternative embodiments, notifications to the electronic device 200 may be recognized by the case 101 through a near field antenna or an electromagnetic field detector. In some embodiments, near field antenna may be a part of the antenna of the electronic device 200, allowing the near field antenna to optionally change the electric parameters of the antenna of the electronic device 200. Electromagnetic fields can be generated by AC or DC currents flowing through wires, such as antennas. In some embodiments, an electromagnetic field detector meter can measure AC electromagnetic fields, which are usually emitted from man-made sources such as electrical wiring in electronic devices 200. In other embodiments, other types of field detectors such as gaussmeters or magnetometers may be used to measure DC fields around an electronic device 200.

In some alternative embodiments, an electromagnetic field detector 35 has several outputs including powering a microcontroller 20, the other to power the analog circuits and the PWM LED controller Rectifier 32 has the output (special), that sends signal to the analog part, that after the amplifying and smoothing is sent to the microcontroller 20, where occurs the recognition the type of the notification (call, SMS, internet). The electromagnetic field detector 35 may detect electromagnetic radiation comprising notifications 300 generated by the electronic device 200 and identify the mode of the electronic device 200 or telephone mode, such a silent mode, and communicate the mode and notifications received to the electronic device 200 to a microcontroller unit 20, such as a LED driver or microcontroller 20. Additionally, the field detector 35 may use communication electromagnetic fields common to communications devices, such as GSM, GPRS, cdmaOne, CDMA2000, EV-DO, EDGE, UMTS, DECT, IS-136/TDMA, iDEN, Wifi, Bluetooth, NFC and the like, received by the electronic device 200 or produced by the electronic device 200 when it receives a notification to identify the type and content of the notification, and to send an electric signal to the microcontroller 20 unit to illuminate one or more display elements 13 on the case 101 depending on the notification received. By identifying the type and content of notifications and the mode of the electronic device, the field detector 35 may transmit this information to the microcontroller 20 which may be configured to illuminate or not to illuminate one or more display elements 13 such as, electronic ink displays, or liquid crystal displays (LCD) in communication with the microcontroller 20. In some embodiments, the harvester 33 has several outputs one of them is powered microcontroller 20, the other may be to power of the analog circuits and the LED controller. The rectifier 32 may provide the output which sends the signal to the analog components for amplifying and smoothing to be applied and then sent to the microcontroller 20 in which the recognition of the type of the notification (call, SMS, internet) may be processed.

In some alternative embodiments, power from the capacitor 34 may be used to power a GSM, GPRS, cdmaOne, CDMA2000, EV-DO, EDGE, UMTS, DECT, IS-136/TDMA, iDEN, Wifi, Bluetooth, NFC or the like antenna which may be used to send an electric signal to a microcontroller 20 or LED driver to activate one or more display elements 13, such as electronic ink displays, liquid crystal displays (LCD), and the like of the case 101 depending on the notification received by the antenna.

In some alternative embodiments, power from the capacitor 34 may be used to power a GSM, CDMA, GPRS, cdmaOne, CDMA2000, EV-DO, EDGE, UMTS, DECT, IS-136/TDMA, iDEN, Wifi, Bluetooth, NFC or the like antenna which may be used to send different information such as time, weather, calendar events, information on incoming or outgoing calls, or information on incoming or outgoing email communications, SMS communications, mms communications, or like information communicated by an electronic device 200 to the one or more display elements 13, such as electronic ink displays, liquid crystal displays (LCD), and the like of the case 101.

Once a notification is identified, in some alternative embodiments, a microcontroller 20 or LED driver may activate one or more display elements 13 such as light emitting diodes (LEDs) or other light elements located on the case 101 or bezel 15. In some embodiments, the LEDs may comprise organic light emitting diodes (OLEDs), flexible LED, LED ring, OLED, AMOLED, Super AMOLED, PMOLED, Transparent OLED, Top-emitting OLED, foldable OLED, white OLED. In further embodiments, any type of light emitting device such as incandescent light bulbs and laser emitters may be used. A microcontroller 20 or LED driver may comprise a small computer on a single integrated circuit or chip containing a processor core, memory, and programmable input/output peripherals. Program memory in the form of NOR flash or OTP ROM may be included on chip, as well as a typically small amount of RAM. In other embodiments, other controllers designed for embedded applications may be used to illuminate the LEDs. In preferred embodiments, the microcontroller 20 and one or more display elements 13 are supplied power from the capacitor 34, power source 17 (FIGS. 1, 2, and 10) such as a battery or power harvester 33, or other electricity storage device. In other embodiments, the microcontroller 20 or LED driver may not activate one or more display elements 13 such as LEDs, for example, if the electromagnetic field detector 35 identifies that the electronic device 200 is not in a silent mode or other mode.

In some embodiments, once a notification is identified a microcontroller 20 may activate one or more display elements 13 such as electronic ink displays, including electrophoretic ink (E-ink) displays, or liquid crystal displays (LCD) located on the case 101. In other embodiments, once a notification is identified a microcontroller 20 may activate one or more display elements 13 such as LED displays or OLED displays located on the case 101 or bezel 12.

In further embodiments, the communication array 21 may comprise a Bluetooth antenna and be configured to be controlled and receive notifications from the electronic device 200 by Bluetooth protocol. In still further embodiments, the communication array 21 may comprise a Wifi antenna and be configured to be controlled and receive notifications from the electronic device 200 by Wifi protocol. In even further embodiments, the communication array 21 may comprise a NFC antenna and be configured to be controlled and receive notifications from the electronic device 200 by NFC protocol.

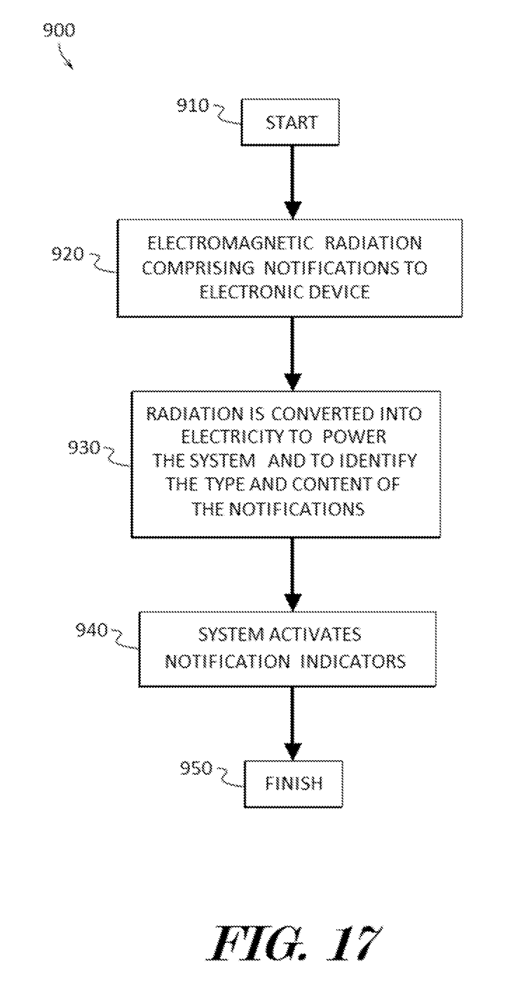

FIG. 17 shows a flow chart that illustrates an example of a method 800 which may be implemented by an alternative example of a notification system 100 (FIGS. 10 and 14) comprising an alternative case 101 (FIG. 16) and an electronic device 200 (FIGS. 1, 2, 10, and 11) in which notifications may be received by and be used to power an electronic device notification case 101 according to various embodiments described herein. In this embodiment, an electronic device 200 (FIGS. 1-11) may receive electromagnetic radiation comprising notifications 300, such as emails, phone calls, video calls, text messages, picture messages, software application messages and alerts, or any other notification common to electronic devices 200 in step 820. The case 101 may then identify the type and content of the notifications and convert the electromagnetic radiation into electricity to power the case 101 in step 830. The system may then activate one or more display elements 13, such as light elements, electronic ink displays, liquid crystal displays (LCD), and the like in step 840. In some embodiments, the display elements 13 may display different notifications with information comprising the type and content of the notifications to the electronic device 200. In other embodiments, the system 100 may receive electromagnetic radiation comprising notifications from the electronic device 200 and then continue with steps 830 and 840 of the method 800.

While some materials have been provided, in other embodiments, the elements that comprise the case 101 may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the case 101 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the case 101 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the case 101 may be coupled by being one of connected to and integrally formed with another element of the case 101.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A case for electronic devices, the case comprising:
an outer case configured to receive an electronic device;
an electronic circuit board retained within the outer case, said electronic circuit board comprising a microcontroller;
a communication array configured to receive electronic notifications from the electronic device, said communication array in communication with said microcontroller; and
a display element in communication with the microcontroller and configured to provide a visual display signal in response to a notification transmitted from the electronic device to the case.

2. The case according to claim 1, wherein the notification is selected from one of an incoming call notification, an SMS message notification, a MMS message notification, a program or application notification, a voice mail notification, missed call notification, or a data network connectivity notification.

3. The case according to claim 2, wherein a first display element is activated after receiving an incoming call notification and a second display element is activated after receiving an SMS message notification.

4. The case according to claim 3, wherein the case comprises a first display element and a second display element which are configured to provide a visual light display through a notification portal positioned on the rear exterior surface of the outer case.

5. The case according to claim 1, wherein the display element comprises a light emitting element.

6. The case according to claim 1, wherein the display element is selected from one of; a LED; a LCD display, an electrophoretic ink display, and an OLED.

7. The case according to claim 1, further comprising a case backing having a bezel configured to align and position a display element with a notification portal.

8. The case according to claim 7, wherein the notification portal comprises indicia allowing transmitted light from a display element to be observed by a user through the case.

9. The case according to claim 1, wherein the case comprises a power source.

10. The case according to claim 9, wherein the power source is selected from one of a battery and a power harvester.

11. The case according to claim 1, wherein the communication array is a wireless communication array comprising a Bluetooth receiver and a Bluetooth transmitter configured to be paired with the electronic device.

12. A system for providing visual display signals to a user through an electronic device case, the system comprising;
an electronic device case comprising a circuit board, a communication array; and a display element;
a microcontroller positioned within the electronic device case and programmed to;
receive a notification signal from the communication array;
determine the type of notification received; and
activate a display element in response to the type of notification received.

13. The system according to claim 12, wherein the type of notification is one of a first notification type, a second notification type, and a third notification type.

14. The system according to claim 13, wherein the first notification type is an incoming call notification and the second notification type is an SMS message notification.

15. The system according to claim 13, wherein upon receiving a first notification type, the case activates a first display element.

16. The system according to claim 13, wherein upon receiving a first notification type, the case activates a first display element and upon receiving a second notification type, the case activates a second display element.

17. The system according to claim 16, wherein the first notification type is an incoming call notification and the second notification type is an SMS message notification.

18. The system according to claim 13, wherein upon receiving a first notification type, the display element displays a first display signal and upon receiving a second notification type, the display element displays a second display signal.

19. The system according to claim 18, wherein the first notification type is an incoming call notification and the second notification type is an SMS message notification.

20. The system according to claim 19, wherein the display element is a light emitting diode and the first display signal is a series of flashes of light generated from the light emitting diode.
